(19) United States
(12) Patent Application Publication
(10) Pub. No.: US 2016/0299866 A1
(43) Pub. Date: Oct. 13, 2016

(54) WIRELESS MODULE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: KAI-LE ZHAI, Wuhan (CN); CHUN-SHENG CHEN, New Taipei (TW)

(21) Appl. No.: 14/699,820

(22) Filed: Apr. 29, 2015

(30) Foreign Application Priority Data
Apr. 10, 2015 (CN) 201510166225.9

(51) Int. Cl. G06F 13/40; G06F 13/42

(52) U.S. Cl. CPC G06F 13/4068; G06F 13/4221

(57) ABSTRACT

A wireless module includes a socket and a wireless plug. The socket is configured to couple to a circuit board. The wireless plug has a coupling unit, a data transmission unit, and a data operation unit. The coupling unit is configured to transfer data between the socket and the data operation unit. The data operation unit is configured to encode data from the coupling unit and decodes data from the data transmission unit. The data transmission unit is configured to send out the encoded data or receive data wirelessly. When the data transmission unit sends out the encoded data, the data is transferred from the socket via the coupling unit and the data operation unit. When the data transmission unit receives data, the received data is transferred to the socket via the data operation unit and the coupling unit.

### FIELD

The subject matter herein generally relates to wireless modules.

### BACKGROUND

Generally, a number of connecting wires, such as power wires and data wires, are required to electronically couple two electronic devices.

### BRIEF DESCRIPTION OF THE DRAWINGS

Implementations of the present technology will now be described, by way of example only, with reference to the attached figures.

FIG. 1 is a block diagram of an embodiment of a wireless module and an electronic device.

FIG. 2 is a block diagram of a first embodiment of the wireless module of FIG. 1.

FIG. 3 is a block diagram of a second embodiment of the wireless module of FIG.

1.

FIG. 4 is a block diagram of a third embodiment of the wireless module of FIG. 1.

FIG. 5 is a circuit diagram of a detection module of the wireless module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

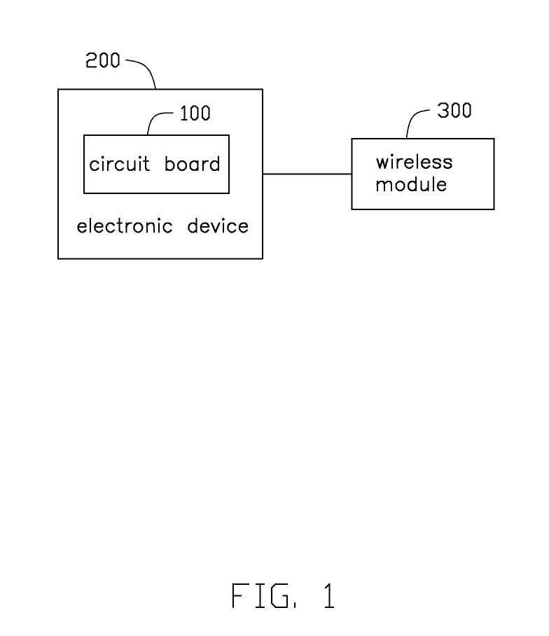

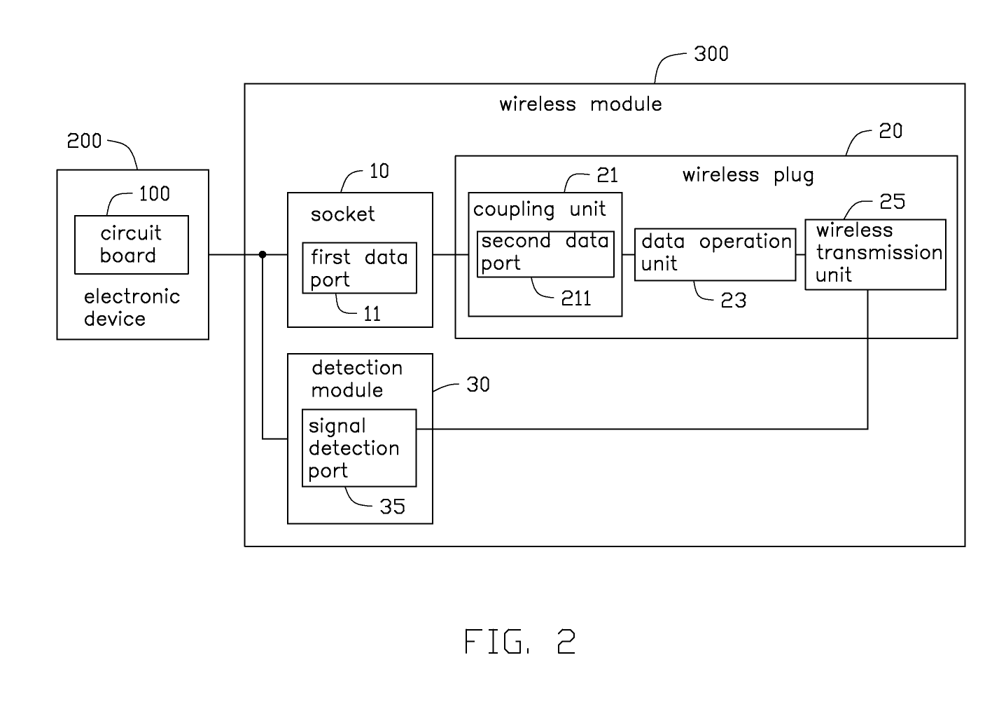

FIG. 1 and FIG. 2 illustrate a wireless module 300 including a socket 10 and a wireless plug 20. The socket 10 is secured to a circuit board 100 of an electronic device 200. In at least one embodiment, the electronic device 200 is a host or monitor, and the socket 10 is a high-definition multimedia interface (HDMI).

The socket 10 can include a first data port 11, which is configured to send data received from the electronic device 200 to the wireless plug 20, or send data received from the wireless plug 20 to the electronic device 200.

The wireless plug 20 can include a coupling unit 21, a data operation unit 23, and a wireless transmission unit 25.

The coupling unit 21 has a second data port 211 coupled to the first data port 11. The second data port 211 is configured to send data received from the first data port 11 to the data operation unit 23, or send data received from the data operation unit 23 to the first data port 11.

The data operation unit 23 is coupled to the coupling unit 21. The data operation unit 23 is configured to encode data received from the second data port 211 and send the encoded data to the wireless transmission unit 25, or decode data received from the wireless transmission unit 25 and then send the decoded data to the second data port 211.

The wireless transmission unit 25 is coupled to the data operation unit 23. The wireless transmission unit 25 is sent the encoded data to another wireless module (not shown), or sends data received from another wireless module to the data operation unit 23.

When the wireless module 300 is mounted to a host, the first data port 11 receives data from the host via the circuit board 100 and sends the data to the second data port 211, the second data port 211 sends the received data to the data operation module 23, the data operation module 23 encodes the received data and sends the encoded data to the wireless transmission unit 25, the wireless transmission unit 25 sends out the encoded data to another wireless module wirelessly.

When the wireless module 300 is mounted to a monitor, the wireless transmission unit 25 wirelessly receives encoded data from another wireless module and sends the encoded data to the data operation unit 23, the data operation module 23 decodes the encoded data and sends the decoded data to the second data port 211, the second data port 211 sends the decoded data to the first data port 11, the first data port 11 sends the decoded data to the monitor via the circuit board 100.

FIGS. 2-4 illustrate that the wireless module 300 further includes a detection module 30. The detection module 30 can be coupled between the circuit board 100 and the socket 10 and include a signal detection port 35, which is configured to detect whether the wireless module 300 is coupled successfully to another wireless module.

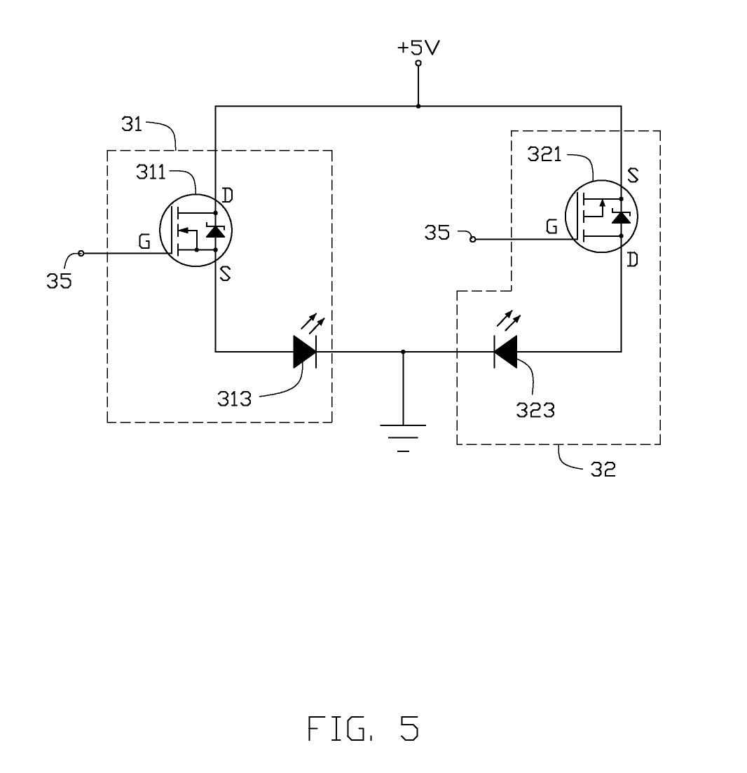

FIG. 5 illustrates the detection module 30 can further include a first detection unit 31 and a second detection unit 32. The first detection unit 31 can include a first transistor 311 and a first indicator 313. The second detection unit 32 can include a second transistor 321 and a second indicator 323. When the wireless module 300 is coupled successfully to another wireless module, the first transistor 311 is switched on to light the first indicator 313, and the second transistor 321 is switched off to turn off the second indicator 323. When the wireless module 300 fails to couple to another wireless module, the first transistor 311 is switched off to turn off the first indicator 313, and the second transistor 321 is switched on to light the second indicator 323. In at least one embodiment, the first indicator 313 is a green luminous diode, and the second indicator is a red luminous diode.

The gate electrode G of the first transistor 311 is coupled to the signal detection port 35, the drain electrode D of the first transistor 311 is coupled to a high level voltage, such as +5V, the source electrode S of the first transistor 311 is coupled to a positive pole of the first indicator 313. A negative pole of the first indicator 313 is grounded.

The gate electrode G of the second transistor 321 is coupled to the signal detection port 35, the drain electrode D of the second transistor 321 is coupled to the high level voltage, the source electrode S of the second transistor 321 is coupled to a positive pole of the second indicator 323. A negative pole of the second indicator 323 is grounded.

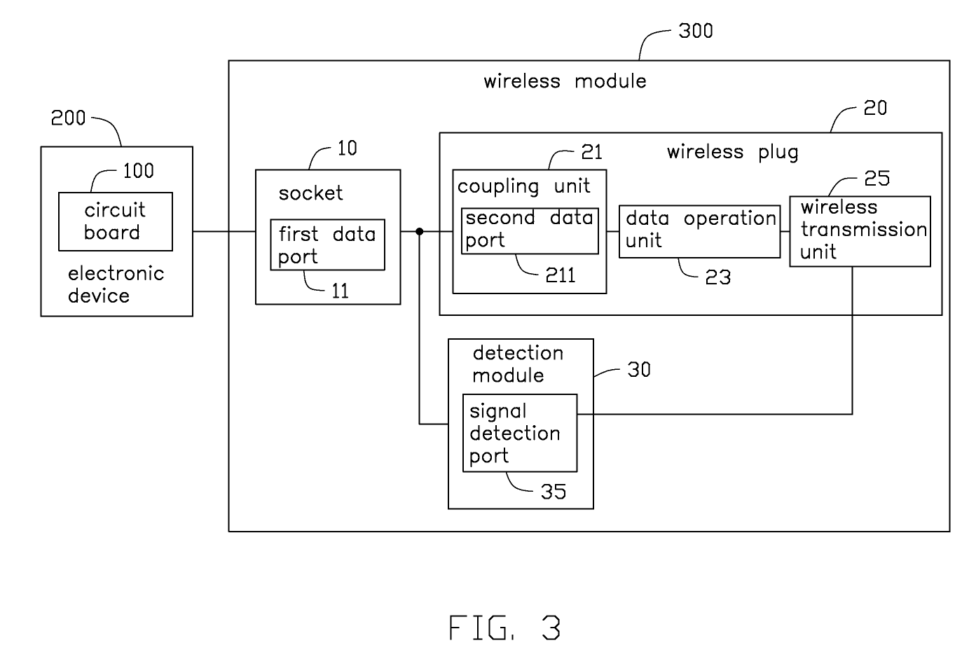

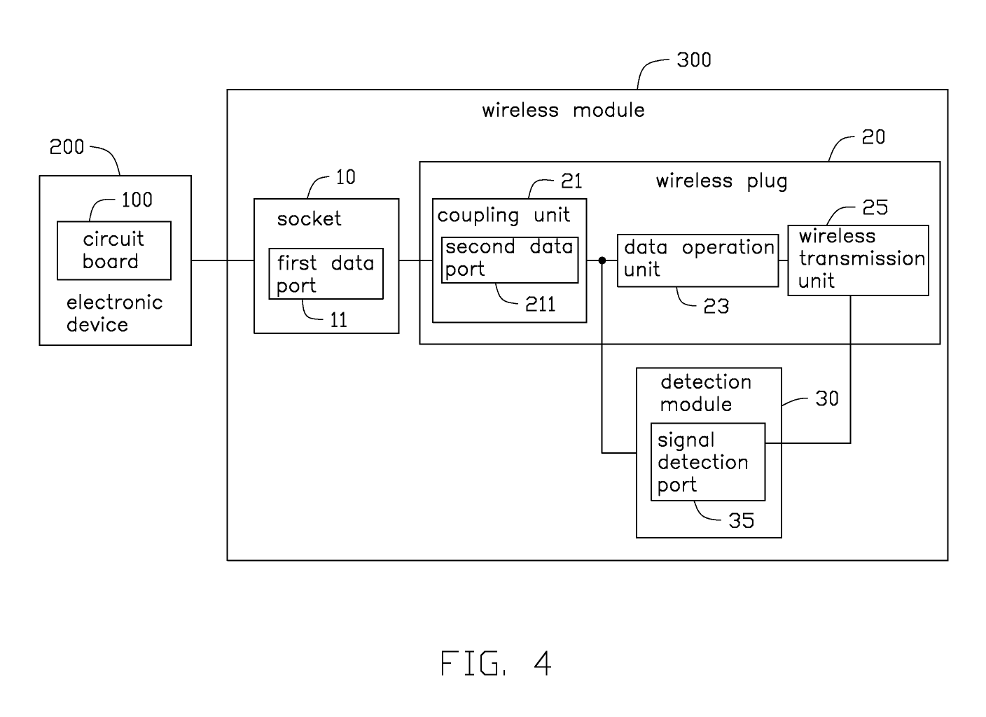

The high level voltage can be received from a power voltage of the coupling unit 21 (shown as in FIG. 4 and FIG. 5), a power voltage of the socket 10 (shown as in FIG. 3 and FIG. 4), or an operation voltage supplied from the circuit board 100 for the socket 10 (shown as in FIG. 2 and FIG. 3).

In at least one embodiment, each of the first transistor 311 and the second transistor 321 is a field-effect tube (FET), and the type of the first transistor 311 is opposite the type of the second transistor 321.

In at least one embodiment, the type of the first transistor 311 is an n-type FET, and the second transistor 321 is a p-type FET.

When the wireless module 300 is coupled successfully to another wireless module, each gate electrode G of the first transistor 311 and the second transistor 321 receives a high level voltage, the first transistor 311 is switched on, and the second transistor 321 is switched off. When the wireless module 300 fails to couple to another wireless module, each gate electrode G of the first transistor 311 and the second transistor 321 receives a low level voltage, the first transistor 311 is switched off, and the second transistor 321 is switched on.

The embodiments shown and described above are only examples. Many details are often found in the art such as the other features of a wireless module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A wireless module comprising:
a socket configured to couple to a circuit board; and
a wireless plug comprising:
a coupling unit coupled to the socket;
a data operation unit coupled to the coupling unit; and
a data transmission unit coupled to the data operation unit;
wherein the coupling unit is configured to transfer data between the socket and the data operation unit;
the data operation unit is configured to encode data received from the coupling unit and decode data received from the data transmission unit; and
the data transmission unit is configured to send the encoded data and receive data; and
wherein the data transmission unit is configured to send the encoded data, in event the encoded data is transferred to another wireless module from the socket via the coupling unit and the data operation unit; and the data transmission unit is configured such that, in event the data transmission unit receives data, the received data is transferred to the socket via the data operation unit and the coupling unit.

2. The wireless module of claim 1, wherein the coupling unit has a first data port, the socket has a second data port, and the first data port is inserted into the second data port.

3. The wireless module of claim 1, further comprising a detection module, wherein the detection module is coupled to detect whether the wireless module is coupled successfully to another wireless module.

4. The wireless module of claim 3, wherein the detection module comprises a first detection unit and a second detection unit, each of the first detection unit and the second detection unit is coupled to a signal detection port, which is configured to detect whether the data transmission unit receives or sends signal; when the wireless module is coupled successfully to another wireless module, the first detection unit is switched on, the second detection unit is switched off; and when the wireless module fails to couple to another wireless module, the first detection unit is switched off, and the second detection unit is switched on.

5. The wireless module of claim 4, wherein the first detection unit comprises a first transistor and a first indicator, the second detection unit comprises a second transistor and a second indicator, when the first detection unit is switched on, the first transistor is switched on to light the first indicator, the second indicator is turned off, and when the second detection unit is switched off, the second the transistor is switched on to light the second indicator, and the first indicator is turned off.

6. The wireless module of claim 5, wherein the first indicator and the second indicator are luminous diodes with different colors.

7. The wireless module of claim 6, wherein the gate electrode of the first transistor is coupled to the signal detection port, the drain electrode of the first transistor is coupled to a high level voltage, the source electrode of the first transistor is coupled to a positive pole of the first indicator, and a negative pole of the first indicator is grounded.

8. The wireless module of claim 7, wherein the gate electrode of the second transistor is coupled to the signal detection port, the drain electrode of the second transistor is coupled to the high level voltage, the source electrode of the second transistor is coupled to a positive pole of the second indicator, and a negative pole of the second indicator is grounded.

9. The wireless module of claim 5, wherein each of the first transistor and the second transistor is a field-effect tube (FET), and the type of the first transistor is opposite the type of the second transistor.

10. The wireless module of claim 9, wherein the first transistor is an n-type FET, and the second transistor is a p-type FET.

11. A wireless module comprising:
a socket configured to couple to a circuit board;
a wireless plug comprising:
a coupling unit coupled to the socket;
a data operation unit coupled to the coupling unit; and
a data transmission unit coupled to the data operation unit; and
a detection module coupled to the data transmission unit and configured to detection when the wireless module is coupled to another wireless module;
wherein the coupling unit is configured to transfer data between the socket and the data operation unit;
the data operation unit is configured to encode data received from the coupling unit and decode data received from the data transmission unit; and
the data transmission unit is configured to send the encoded data or receive data from wireless when the wireless module is coupled to another wireless module;
wherein the data transmission unit is configured to send the encoded data, in event the encoded data is transferred to another wireless module from the socket via the coupling unit and the data operation unit; and the data transmission unit is configured such that, in event the data transmission unit receives data, the received data is transferred to the socket via the data operation unit and the coupling unit.

12. The wireless module of claim 11, wherein the coupling unit has a first data port, the socket has a second data port, and the first data port is inserted into the second data port.

13. The wireless module of claim 11, wherein the detection module comprises a first detection unit and a second detection unit, each of the first detection unit and the second detection unit is coupled to a signal detection port, which is configured to detect whether the data transmission unit receives or sends signal; when the wireless module is coupled successfully to another wireless module, the first detection unit is switched on, the second detection unit is switched off; and when the wireless module fails to coupled to another wireless module, the first detection unit is switched off, the second detection unit is switched on.

14. The wireless module of claim 13, wherein the first detection unit comprises a first transistor and a first indicator, the second detection unit comprises a second transistor and a second indicator, when the first detection unit is switched on, the first transistor is switched on to light the first indicator, the second indicator is turned off, and when the second detection unit is switched off, the second the transistor is switched on to light the second indicator, and the first indicator is turned off.

15. The wireless module of claim 14, wherein the first indicator and the second indicator are luminous diodes with different colors.

16. The wireless module of claim 14, wherein the gate electrode of the first transistor is coupled to the signal detection port, the drain electrode of the first transistor is coupled to a high level voltage, the source electrode of the first transistor is coupled to a positive pole of the first indicator, and a negative pole of the first indicator is grounded.

17. The wireless module of claim 16, wherein the gate electrode of the second transistor is coupled to the signal detection port, the drain electrode of the second transistor is coupled to the high level voltage, the source electrode of the second transistor is coupled to a positive pole of the second indicator, and a negative pole of the second indicator is grounded.

18. The wireless module of claim 17, wherein the high lever voltage is received from a power voltage of the coupling unit, a power voltage of the socket, or an operation voltage supplied from the circuit board for the socket.

19. The wireless module of claim 14, wherein each of the first transistor and the second transistor is a field-effect tube (FET), and the type of the first transistor is opposite the type of the second transistor.

20. The wireless module of claim 19, wherein the first transistor is an n-type FET, and the second transistor is a p-type FET.
